(19) United States
(12) Patent Application Publication
(10) Pub. No.: US 2020/0153538 A1
(43) Pub. Date: May 14, 2020

(54) METHOD AND NODE FOR DECODING OR ENCODING USER DATA BASED ON A TBS INDEX

(71) Applicants: Xixian CHEN, Ottawa (CA); Jung-Fu CHENG, Fremont, CA (US); James Jianfeng WENG, Kanata (CA); Jun Wang, Kanata (CA)

(72) Inventors: Xixian CHEN, Ottawa (CA); Jung-Fu CHENG, Fremont, CA (US); James Jianfeng WENG, Kanata (CA); Jun Wang, Kanata (CA)

(73) Assignee: TELEFONAKTIEBOLAGET LM ERICSSON (PUBL), Stockholm (SE)

(21) Appl. No.: 16/620,129

(22) PCT Filed: Jun. 13, 2018
(86) PCT No.: PCT/IB2018/054337

§ 371 Date: Dec. 6, 2019

Related U.S. Application Data
(60) Provisional application No. 62/520,934, filed on Jun. 16, 2017.
(60) Provisional application No. 62/520,914, filed on Jun. 16, 2017.

(51) Int. Cl. H04L 1/00

(52) U.S. Cl. CPC H04L 1/0003; H04L 1/0058; H04L 1/0028; H04L 1/0016; H04L 1/0026

(57) ABSTRACT

There is provided a method performed by a wireless device for handling user data. The method comprises: receiving an index (such as a Transport Block Size (TBS) index) from a network node; determining a TBS based on the received index; determining a modulation order based at least on the determined TBS; and performing one of decoding and encoding the user data based at least on the determined modulation order.

### RELATED APPLICATIONS

The present application claims the benefits of priority of U.S. Provisional Patent Application No. 62/520934, entitled “TBS and Modulation Order determination for 5G NR”, and filed at the United States Patent and Trademark Office on Jun. 16, 2017 and also of U.S. Provisional No. 62/520914, entitled “A new method to support different modulations within one codeword in 5G NR”, and filed at the United States Patent and Trademark Office on Jun. 16, 2017. The content of the two provisional applications is incorporated herein by reference.

### TECHNICAL FIELD

The present description generally relates to wireless communication networks and more particularly to decoding or encoding user data based on a Transport Block Size (TBS) index in such networks.

### BACKGROUND

3GPP has now started its journey towards 5G NR (New Radio), and there are quite a large number of areas where improvements over Long Term Evolution (LTE) can be made.

In LTE, the modulation and coding schemes are selected jointly. Scheduler and link adaptation work together to decide the number of scheduling blocks (SBs) to be allocated and the modulation and coding scheme (MCS) to be used, given an estimation of the prevailing link quality and the amount of data which is desired to be transmitted in a given Transmission Time Interval (TTI). This process can be complex and time consuming, since the corresponding Transport Block size (TBS) has to be selected through a large two dimensional (size 27*100) TBS table (see 3GPP TS 36.213, E-UTRA Physical layer procedures, v10.9.0). Multiple TBS tables are required for 1, 2, 4, and 8 layers, respectively.

To reduce the complexity, an existing solution proposes to remove the large TBS table from the 5G standard. Instead, a smaller table (see below) is designed to select the MCS index first.

TABLE 1
MCS index, modulation order and code rate table for PDSCH

| MCS | Modulation | Code |
|---|---|---|
| Index | Order | Rate |
| I_{MCS} | Qₘ | R × 1024 |
| 0 | 2 | 120 |
| 1 | 2 | 193 |
| 2 | 2 | 308 |
| 3 | 2 | 449 |
| 4 | 2 | 602 |
| 5 | 4 | 378 |
| 6 | 4 | 434 |
| 7 | 4 | 490 |
| 8 | 4 | 553 |
| 9 | 4 | 616 |
| 10 | 4 | 658 |
| 11 | 6 | 466 |
| 12 | 6 | 517 |
| 13 | 6 | 567 |
| 14 | 6 | 616 |
| 15 | 6 | 666 |
| 16 | 6 | 719 |
| 17 | 6 | 772 |
| 18 | 6 | 822 |
| 19 | 6 | 873 |
| 20 | 8 | 682.5 |
| 21 | 8 | 711 |
| 22 | 8 | 754 |
| 23 | 8 | 797 |
| 24 | 8 | 841 |
| 25 | 8 | 885 |
| 26 | 8 | 916.5 |
| 27 | 8 | 948 |
| 28 | 2 | Reserved |
| 29 | 4 | |
| 30 | 6 | |
| 31 | 8 | |

The User Equipment (UE) shall use the MCS index and Table 1 to determine the modulation order and code rate for the physical downlink shared channel. Denote N_{RE}^{PRB} as the nominal number of resource elements per Physical Resource Block (PRB) in the PRBs allocated for Physical Downlink Shared Channel (PDSCH), i.e., a predefined number of resource elements per PRB. Denote L^{DL} as the number of layers the codeword is mapped to, after the transport block is encoded into the codeword. The transport block size (TBS) in bits is determined by:

$$TBS = 8 \times ⌈ \frac{{N}_{PBR}^{DL} \times {N}_{RE}^{PRB} \times {L}^{DL} \times M \times {R}_{coding}}{8} ⌉ \qquad ( 1 )$$

Where N_{PRB}^{DL} denotes the number of PRBs allocated to a wireless device (for example), M stands for the modulation order, and R_{coding} stands for the code rate.

Note that MCS indexes from 0 to 27 are used for a new transmission or DTXed re-transmission (a retransmission due to a discontinued transmission of the original transmission when the UE failed to decode the Downlink Control Information (DCI) transmitted on the Physical Downlink Control Channel (PDCCH)). MCS indexes from 28 to 31 are used for a re-transmission, those 4 special values [28-31] are used to explicitly indicate the modulation order in the retransmission.

Furthermore, both LTE and 5G NR use a clever algorithm to implement incremental redundancy and adaptive coding. The coded bits are interleaved and placed into a circular buffer called the soft buffer. Bits are copied from the buffer starting at a position that depends on the redundant version (RV). The starting position for RVₙ is approximately n/4 of the way around the circular buffer. The number of bits pulled from the circular buffer for each RV depends on the target code rate. For poor channel conditions, the code rate approaches 0.1, in which case the entire soft buffer is transmitted multiple times each RV. In excellent channel conditions, the code rate approaches 0.92, which means the number of bits transmitted in each RV is slightly more than the number of bits in the transport block.

Redundant version 0 is often used for the initial/original transmission. If a negative acknowledgment (NACK) is received from the UE, other Redundant version values can be used for re-transmission to enable the UE to implement an incremental redundancy and thus improve the decoding performance.

### SUMMARY

There currently exist certain challenge(s).

The aforementioned nominal number of resource elements (REs) per PRB (N_{RE}^{PRB}) based TBS determination method for 5G NR has the following drawbacks:

### 1) Large Quantization Error in TBS Due to All PRBs Being Assumed to Have the Same Number of REs

The N_{RE}^{PRB} is used to determine the TBS value. However, if the actual number of REs per PRB is quite different from the N_{RE}^{PRB} (considering those PRBs including Master Information Block (MIB), Demodulation Reference Signal (DMRS), . . . ), the quantization error may become large. As a result, the network node (e.g. 5 gNB) has to inform the UE the new N_{RE}^{PRB} through signaling to reduce the quantization error. That consumes extra radio resources.

### 2) There is No Good Matching of the Actual Air Channel Transmission Capability

Based on the TBS calculation formula (1), once the MCS index is determined according to the UE's channel quality, the TB size is linearly proportional to the number of PRBs used and the number of layers. However, the actual air channel transmission capability is rather nonlinear, i.e., being non-proportional to the number of PRBs, especially for large number of PRBs as shown in FIG. 1. So, such a linear formula may not be able to fully exploit the advantages of Low Density Parity Check (LDPC) coding characteristics.

### 3) Bundling of TBS With Modulation

The existing 3GPP standard uses a TBS table-centric method to determine the TB size and to avoid the linearity issue, but it imposes an inherent bundling relationship between the TBS and modulation, i.e. when using the MCS index to look up the TBS table, the TBS and the modulation order are determined simultaneously. In reality, the TBS is an independent concept from the modulation. In some cases, for example, if many REs in one PRB are reserved for other purposes, such as DMRS or MIB, the Transport Block (TB) size on the PRB will be decreased accordingly. This has nothing to do with the UE's current channel quality, i.e. even if the TBS is small, it still should be able to support high modulation order. However, the existing LTE standard prevents application of high modulation orders to small TBS, which can't fully utilize the UE's best channel quality. As such, the air interface transmission efficiency will be impacted, which is a critical factor in 5gNR.

### 4) Lack of Flexibility to Deal with DTX Re-Transmission

When DTX (Discontinuous transmission) is detected on the Hybrid Automatic Repeat Request (HARQ) feedback, the same number of PRBs, layers, and modulation order have to be used for the re-transmission, due to the fact that if the number of PRBs is changed in retransmission, it will be very difficult to find another MCS to produce the same TBS using formula (1).

To mitigate the above drawbacks, a new solution is proposed and described in this disclosure. The new solution, referred to as the TBS-centric solution, includes the following features:
A TBS index instead of a MCS index is notified to the UEs, which is given by a 5 bit field in the DCI, for example.
The number of nominal PRBs is used to determine the TBS value instead of using the number of actual PRBs as used in LTE.
Instead of using formula (1), which is linear, to calculate the TB size, a nonlinear TBS table is defined which uses a 5-bit TBS index and number of nominal PRBs to determine the final TBS.
The RE efficiency is used to determine the modulation order for both a new transmission and a retransmission. Moreover, the modulation order derivation method can be applied to the UpLink (UL) to support modulation change in UL retransmission.
The Redundant Version (RV) is merged into the TBS table, which not only reduces the DCI size by two bits, but also increases the TBS levels from 28 to 29.

There are, proposed herein, various embodiments which address one or more of the issues disclosed herein.

Certain embodiments may provide one or more of the following technical advantage(s).
The number of nominal PRBs is used to determine the TBS value instead of using the number of actual PRBs as used in LTE. As a result, the TBS quantization error is greatly reduced. In the embodiments, a nominal number of PRBs replaces a number of physical PRBs.
The embodiments are more flexible and more accurate: since the actual TBS values can be specified in a table (i.e. the new TBS table), each column of the table can be determined independently, which then can support nonlinear TBS setting based on the allocated PRB number to align with the actual channel model. As such, the quantization error can be decreased to a minimum extent. For example, if it is perceived that the middle part of the table is used more often than the lower or higher end parts, the TBS values in the middle part of the table could be made denser than the two ends' parts. As such, the TBS values are more flexible and accurate.
The new TBS table only specifies TB sizes and has nothing to do with modulation which can be implicitly derived based on the Resource Element (RE) efficiency. In this way, regardless of how small the TBS can be due to the fact that many REs in one PRB are reserved for other purposes, the most appropriate modulation can be always applied to match the UE's channel quality. This is done by decoupling the TBS from the modulation parameter.
Based on the implicit modulation derivation mechanism, the existing 4 modulation indicator (having index values [28-31]) in the TBS table for a retransmission become duplicate and can be replaced with other information, such as Redundancy Version. As a result, the existing 2-bit RV field can be removed so that the Downlink Control Information (DCI) size is decreased by two bits, which will greatly improve PDCCH blind detection performance.
When DTX (Discontinuous transmission) is detected on the HARQ feedback, the TBS-centric solution can easily find the same TBS from the table for the re-transmission regardless of the number of layers, modulation orders, number of PRBs used, etc., since the value in each column of the TBS table is independently specified, which allows for the same TBS value shown in different columns. This feature is important for performing a DTX re-transmission.

According to one aspect, some embodiments include a method performed by a wireless device for handling user data. The method generally comprises: receiving an index from a network node; determining a Transport Block Size (TBS) based on the received index; determining a modulation order based at least on the determined TBS; and performing one of decoding and encoding the user data based at least on the determined modulation order.

For example, the received index can be the TBS index.

According to another aspect, some embodiments include a wireless device configured, or operable, to perform one or more functionalities (e.g. actions, operations, steps, etc.) of the wireless device as described herein.

In some embodiments, the wireless device may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the wireless device may comprise one or more functional modules configured to perform one or more functionalities as described herein.

According to another aspect, some embodiments include a non-transitory computer-readable medium storing a computer program product comprising instructions which, upon being executed by processing circuitry (e.g., at least one processor) of the wireless device, configure the processing circuitry to perform one or more functionalities as described herein.

According to another aspect, some embodiments include a method performed by a base station for allocating resources for a transmission of user data to a wireless device. The method generally comprises: determining the resources to be allocated to the wireless device; determining an index based at least on the determined resources allocated to the wireless device; and sending the determined index to the wireless device.

According to another aspect, some embodiments include a network node or base station configured, or operable, to perform one or more functionalities (e.g. actions, operations, steps, etc.) of the network node as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the network node may comprise one or more functional modules configured to perform one or more functionalities as described herein.

According to another aspect, some embodiments include a non-transitory computer-readable medium storing a computer program product comprising instructions which, upon being executed by processing circuitry (e.g., at least one processor) of the network node, configure the processing circuitry to perform one or more functionalities as described herein.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 shows a graph illustrating the existing nonlinear TBS table.

FIG. 2 is a flow chart of operations of a wireless device in accordance with some embodiments.

FIG. 3 is a flow chart of operations of a radio network node in accordance with some embodiments.

FIG. 4 is a block diagram of a wireless device in accordance with some embodiments.

FIG. 5 is a block diagram of a radio network node in accordance with some embodiments.

FIG. 6 is a flow chart of operations of a wireless device in accordance with some embodiments.

FIG. 7 illustrates a signal diagram between a wireless device and a base station, in accordance with some embodiments.

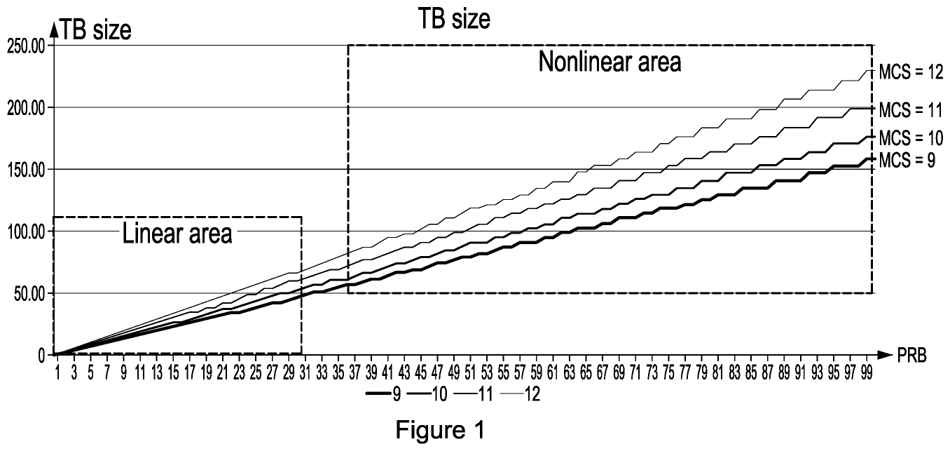

FIG. QQ1 is a block diagram of a wireless network.

FIG. QQ2 is a block diagram of a UE in accordance with some embodiments.

FIG. QQ3 is a schematic block diagram of a virtualization environment.

FIG. QQ4 is a schematic block diagram of a communication system.

FIG. QQ5 is a schematic block diagram of a communication system with a host computer.

FIG. QQ6 is a flowchart illustrating a method implemented in a communication system, in accordance with one embodiment.

FIG. QQ7 is a flowchart illustrating a method implemented in a communication system, in accordance with one embodiment.

FIG. QQ8 is a flowchart illustrating a method implemented in a communication system, in accordance with one embodiment.

FIG. QQ9 is a flowchart illustrating a method implemented in a communication system, in accordance with one embodiment.

### DETAILED DESCRIPTION

The embodiments set forth below represent information to enable those skilled in the art to practice the embodiments. Upon reading the following description in light of the accompanying figures, those skilled in the art will understand the concepts of the description and will recognize applications of these concepts not particularly addressed herein. It should be understood that these concepts and applications fall within the scope of the description.

Generally, all terms used herein are to be interpreted according to their ordinary meaning in the relevant technical field, unless a different meaning is clearly given and/or is implied from the context in which it is used. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The present disclosure teaches TB size determination that is applicable to both Downlink (DL) and UL data transmissions.

As mentioned above, in the existing solution and systems, the modulation order and code rate are closely related, which is represented by the MCS index. Once the MCS index is determined, its corresponding modulation order and code rate can be found using Table 1. Then, the TBS can be determined using formula (1). The existing solution is focused on notifying the UE a determined MCS index for the transmission efficiency, which is given by: transmission efficiency=modulation order*code rate, to indicate the number of bits per RE that can be supported.

The present disclosure proposes to focus on notifying the UE a determined TBS index rather than a determined MCS index. This new solution is a TBS centric method and it can address the short-comings of the existing solution as discussed above. By so doing, the TBS is decoupled from the modulation order. Furthermore, the present disclosure teaches the use of a signaling field of 5 bits as an exemplary signaling size to convey the TBS index. To one skilled in the art, it is clear that a signaling field of a different size can be used.

### Embodiment 1: Use of a 5-Bit TBS Index (TBSI) to Replace the 5-Bit MCS Index

If it is assumed that all the layers of one codeword use the same modulation order, a network node such as gNB or SgNB will notify a UE the new 5-bit TBS index replacing the 5-bit MCS index in a DCI field, for example. As such, the structure of the DCI field remains unchanged. The SgNB will also notify the UE the existing resource blocks allocated to it through the scheduling control signaling (DCI). Using such information, i.e. the TBS index and the allocated resource blocks, the UE can determine the TB size, the modulation order as well as the code rate. The determination of the TB size, the modulation order and the code rate can be summarized as follows:

Step 1: Calculate the total actual number of REs (N_{RE}) based on the allocated resource blocks;

Step 2: Determine the number of nominal PRBs (N_{PRB}^{norm}) based on the actual number of REs (N_{RE}) calculated in step 1 and a nominal number of REs per PRB (N_{RE}^{PRB}) by using the following formula;

$${N}_{PRB}^{norm} = ⌈ \frac{{N}_{RE}}{{N}_{RE}^{PRB}} ⌉ \qquad ( 2 )$$

It should be noted that the nominal PRB is a logic resource concept with a predefined number of REs (128 or 64) whereas the physical PRB is a real resource block. Formula 2 describes the conversion relationship (or scaling relationship) between them.

Step 3: Use the 5-bit TBSI and the number of nominal PRBs (N_{PRB}^{norm}) to look up a TBS table (see Table 2 below) to determine the TB size;

Step 4: Calculate the transmission efficiency REefficiency using the following formula;

$$REefficiency = \frac{TBS}{{N}_{RE}} \qquad ( 3 )$$

Step 5: Use the calculated efficiency to determine the corresponding modulation order.

Now, embodiment 1 will be described in more detail.

An exemplary TBS table for embodiment 1 is shown in Table 2. The UE will use the TBS index and the number of nominal resource blocks (N_{PRB}^{norm}) to determine the TBS value. Each nominal PRB contains a fixed nominal number of REs. In one nonlimiting example, the nominal number of REs is set to 128. In another nonlimiting example, the nominal number of REs is set to 64 such that the TBS determination resolution can be increased. In a further nonlimiting embodiment, the TBS table (Table 2) contains columns corresponding to integer number of nominal PRBs as well as columns corresponding to fractional number of nominal PRBs. In one nonlimiting example, additional columns corresponding to 0.1, 0.2, . . . , 0.9, 1.1, 1.2, 1.3, . . . , 1.9 nominal number of PRBs are included in the TBS table in addition to those illustrated in Table 2.

Furthermore, to support wider bandwidth operations in NR, the number of columns (corresponding to the nominal number of PRBs) can be larger than 100. The TBS table is designed to include the number of columns that will be used in expected and normal operation modes. The TBS table can be designed through simulations or field test results, for example. A person skilled in the art would appreciate that the TBS table could be designed in other ways.

Note that TBS indexes from 0 to 27 are used for new transmissions or DTXed re-transmissions. TBS indexes from 28 to 31 are used for re-transmissions, which only contain modulation order information, since the UE already knows the TBS from the original transmission.

TABLE 2
Illustration of the TBS table (comprising quantized TBS values)
for embodiment 1

| | 1 | 2 | | 100 |
|---|---|---|---|---|
| TBS | nrofNominalRb | nrofNominalRbs | | nrofNominalRbs |
| Index | (N_{PRB}^{norm}) | (N_{PRB}^{norm}) | . . . | (N_{PRB}^{norm}) |
| 0 | TBS_{0,1} | TBS_{0,2} | . . . | TBS_{0,100} |
| 1 | TBS_{1,1} | TBS_{1,2} | . . . | TBS_{1,100} |
| . . . | . . . | . . . | . . . | . . . |
| 27 | TBS_{28,1} | TBS_{28,2} | . . . | TBS_{28,100} |
| 28 | QPSK | QPSK | . . . | QPSK |
| 29 | 16QAM | 16QAM | . . . | 16QAM |
| 30 | 64QAM | 64QAM | . . . | 64QAM |
| 31 | 256QAM | 256QAM | . . . | 256QAM |

Table 3 illustrates a table showing the relation between the RE efficiency and the Modulation Order. This table can be designed through simulations, for example. Other methods and techniques can be used to design this table, as will be appreciated by a person skilled in the art.

This table is to be used for deriving the modulation order from the TBS index, as can be seen below.

TABLE 3
RE Efficiency and Modulation Order

| | Modulation | RE |
|---|---|---|
| | Order (M) | Efficiency × 256 |
| 0 | 2 | 60 |
| 1 | 2 | 96.5 |
| 2 | 2 | 154 |
| 3 | 2 | 224.5 |
| 4 | 2 | 301 |
| 5 | 4 | 378 |
| 6 | 4 | 434 |
| 7 | 4 | 490 |
| 8 | 4 | 553 |
| 9 | 4 | 616 |
| 10 | 4 | 658 |
| 11 | 6 | 699 |
| 12 | 6 | 775.5 |
| 13 | 6 | 850.5 |
| 14 | 6 | 924 |
| 15 | 6 | 999 |
| 16 | 6 | 1078.5 |
| 17 | 6 | 1158 |
| 18 | 6 | 1233 |
| 19 | 6 | 1309.5 |
| 20 | 8 | 1365 |
| 21 | 8 | 1422 |
| 22 | 8 | 1508 |
| 23 | 8 | 1594 |
| 24 | 8 | 1682 |
| 25 | 8 | 1770 |
| 26 | 8 | 1833 |
| 27 | 8 | 1896 |

In the following, a method for a UE to decode received user data, such as a user data block or a transport block (TB) for a new transmission or DTXed retransmission, is described, with the UE receiving a DCI on PDCCH including an index (e.g. a TBS index) and a PRB resources indicator, which indicates the number and position of the resources assigned or allocated to the UE. The decoding (or encoding) method comprises the modulation order determination method as described above with regards to embodiment 1.

Step 10: Calculate the total actual number of REs in the assigned physical layer resources, denoted as N_{RE}. If we assume that all the assigned PRBs have the same number of REs, N_{RE} can be calculated as: N_{RE}=N_{PRB}^{DL}×N_{RE}^{PRB′}×L^{DL}

where L^{DL} is the number of layers for the downlink, N_{PRB}^{DL} is the number of PRBs and N_{RE}^{PRB′} is the actual number of REs per PRB for the current transmission. If not all the assigned PRBs have the same number of REs, the total number of REs (N_{RE}) can be found through summing the number of REs from each of the assigned PRBs. For instance, REs used for Channel State Information-reference Signal (CSI-RS), Phase Tracking RS (PT-RS) or other non-data carrying REs are not included in the usable number of REs.

Step 12: Calculate the number of equivalent nominal resource blocks (N_{PRB}^{norm}):

$${N}_{PRB}^{norm} = ⌈ \frac{{N}_{RE}}{{N}_{RE}^{PRB}} ⌉$$

where N_{RE}^{PRB} denotes the nominal number of REs in one nominal PRB, which is a pre-defined fixed value, and

$$⌈ \frac{x}{y} ⌉$$

is the ceiling function/operation.

Step 14: By using the TBS index and N_{PRB}^{norm}, the corresponding TBS can be found using Table 2.

If N_{PRB}^{norm} exceeds the number of columns in the TBS table (Table 2) in certain special operation modes, the following method can be applied to determine the TBS value. The exemplary embodiment is presented assuming the TBS table has 100 columns for N_{PRB}^{norm}.

a) Calculate

$$m = ⌊ \frac{{N}_{PRB}^{norm}}{100} ⌋$$

and n=N_{PRB}^{norm} (mod 100), where

$$⌊ \frac{x}{y} ⌋$$

is the floor function/operation and mod is the modulo operation.

b) Use the TBS index and Colum 100 in Table 2 and find its corresponding TBS value denoted as tbs100.

c) Use the TBS index and Colum n in Table 2 and find its corresponding TBS value denoted as tbsRemainder.

d) The actual TBS value is calculated from TBS=m*tbs100+tbsRemainder.

Step 16: Calculate the RE efficiency as:

$$reEfficiency = \frac{TBS}{{N}_{RE}} .$$

Step 18: The modulation order can be determined via one of the following examples.

### Example 18-1

Search through the RE Efficiency Colum in Table 3 and find the closest RE Efficiency value which is less than or equal to the calculated ReEfficiency and its corresponding modulation order. In a further nonlimiting exemplary implementation of this embodiment, the table used to determine the modulation order can be reduced to a smaller size such as the one provided in Table 4 (see below). Tables 3 and 4 can be designed through simulations or using other methods as will be appreciated by a person skilled in the art.

TABLE 4
RE Efficiency and Modulation Order

| | Modulation | RE |
|---|---|---|
| | Order (M) | Efficiency × 256 |
| 0 | 2 | 0 |
| 1 | 4 | 378 |
| 2 | 6 | 699 |
| 3 | 8 | 1365 |

### Example 18-2:

The calculated RE efficiency is compared to a set of thresholds to determine the modulation order. In one non-limiting exemplary embodiment, the modulation order is determined as follows:

if REefficiency<378/256:
M=b 2

elseif REefficiency<699/256:
M=4

elseif REefficiency<1365/256:
M=6

else:

M=8

Step 20: Calculate the total number of raw physical bits, N_{bits} (the coded bits):

N_{bits}=N_{RE}*M

Step 22. Based on the TBS value and N_{bits} (the number of coded bits), the UE can try to decode (or encode) the user data or transport block.

In the above, the decoding method and modulation order determination method have been described in the downlink direction, using parameters (such as the number of layers, the number of allocated PRBs) for the downlink. It would be appreciated by a person skilled in the art that these methods can be easily adapted for the uplink direction, using corresponding parameters for the uplink. As such, the UE can encode user data based on the determined TBS value and the N_{bits} for transmission to the network node.

It should be also noted that the modulation order determination method in the above can use a different table or a different set of thresholds for DL or UL transmissions.

For example, the modulation order determination method can use a different table or a different set of thresholds for Orthogonal Frequency Division Multiplexing (OFDM)-based or Discrete Fourier Transform (DFT)-S-OFDM-based transmission waveforms. They can use a different table or a different set of thresholds for data from different transport channels. One nonlimiting example is to limit the modulation order to QPSK for paging or random access reply.

The modulation order determination method can use a different table or a different set of thresholds for data from different logical channels. One nonlimiting example is to limit the modulation order to QPSK for data requiring high reliability.

The modulation order determination method can use a different table or a different set of thresholds based on UE capabilities. One nonlimiting example is to remove the 256QAM entry from the modulation order search table or modulation order threshold set if the UE does not support 256QAM.

The modulation order determination method can use a different table or a different set of thresholds based on high layer signaling. One nonlimiting example is via radio resource control layer signaling.

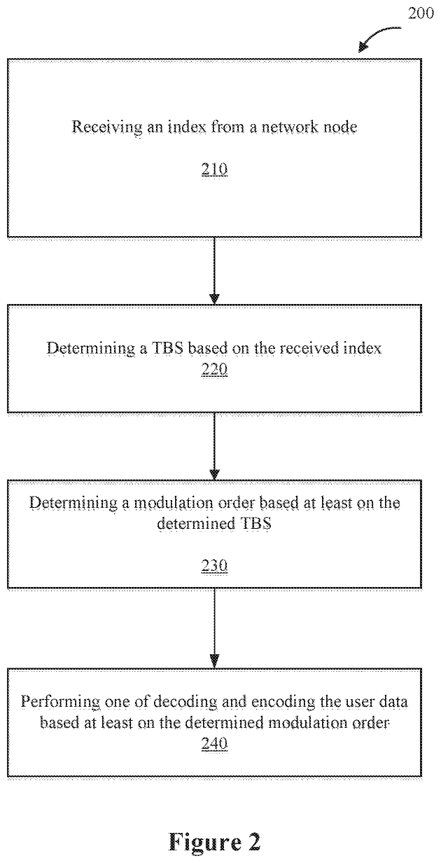

Now turning to FIG. 2, a method 200 for handling user data, such as a transport block, will be described. The method 200 can be implemented in a wireless or terminal device, for example. Method 200 starts with receiving an index from a network node (block 210). The index can be the TBS index, which may be contained in a DCI signaling, for example.

Method 200 continues with determining a TBS based on the received index (block 220). In some embodiments, the TBS can be determined as described in steps 10-14 (using Table 2, for example). For example, determining the TBS based on the received TBS index may comprise looking up a 2-dimensional table to find a value of the TBS corresponding to the received TBS index and the nominal number of resource blocks.

Method 200 continues with determining a modulation order based on the determined TBS (block 230). In some embodiments, the modulation order can be determined as described above in steps 14-18. For example, the determination of the modulation order may comprise: determining the TBS based on the received TBS index and a nominal number of resource blocks; determining a resource element (RE) efficiency based on the determined TBS; and determining the modulation order based on the determined resource element efficiency. The nominal number of resource blocks can be determined by scaling a total number of resource elements in the resource blocks allocated by the network node to the wireless device, with a factor which can be configured. In some embodiments, determining the modulation order may comprise looking up a table of RE efficiency to determine the modulation order corresponding to the determined RE efficiency. In some embodiments, determining the modulation order may comprise comparing the determined RE efficiency with a set of threshold values of RE efficiency and selecting a corresponding modulation order.

Method 200 continues with performing decoding or encoding the user data (or transport block) based at least on the determined modulation order (block 240). In some embodiments, the decoding is done according to steps 20-22 as described above. For example, method 200 may comprise determining a total number of coded bits based on the modulation order and a total number of resource elements in the assigned resource blocks. In some embodiments, decoding or encoding the user data may further comprise decoding or encoding the user data based on the determined TBS and the total number of coded bits.

In some embodiments, the wireless device may further receive an indicator or an indication of the resources allocated for the wireless device, by the network node or base station.

In some embodiments, determining the resource element (RE) efficiency may be further based on a total number of resources elements in the resource blocks allocated by the network to the wireless device.

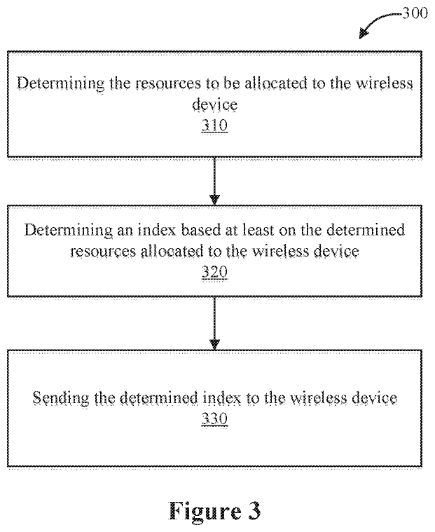

FIG. 3 illustrates a method 300 performed by a base station (or network node such as gNB or 5gNB) for allocating resources for a transmission of user data to a wireless device. Method 300 comprises: determining the resources to be allocated to the wireless device (block 310); determining an index based at least on the determined resources allocated to the wireless device (block 320) and sending the determined index to the wireless device (block 330). The determined index can be the TBS index, for example.

In some embodiments, in block 310, to determine the resources to be allocated, the network node estimates a UE's efficiency based on a UE reported Channel Quality Information (CQI). The network node can also determine the wireless channel quality, based on the CQI reported by the UE. To estimate the efficiency, the base station updates the UE's channel condition (e.g. Signal to Interference plus Noise Ratio (SINR)) based on the received CQI report as well as the inner-loop adjustment. Then, the base station converts the SINR into a corresponding efficiency (bits/RE) and modulation order. The network node allocates the resources (e.g. PRB resources) according to the estimated efficiency and the buffered data volume.

In some embodiments, in block 320, the network node calculates the TBS as follows: TBS=RE efficiency*total RE number in the allocated resources. The network node also calculates the nominal PRB number using formula 2. Then, the network node uses the calculated TBS and the nominal PRB number to look up Table 2 to find a quantized TBS value closest to the determined TBS, whose row number corresponds to the TBS index. The determined TBS index can be validated as follows.

In some embodiments, the base station recalculates the actual efficiency through dividing the quantized TB size by the total RE number, the total RE number being used to derive the modulation order using the same efficiency table as the UE (see e.g. Tables 3 and 4). If the derived modulation order is the same as the value determined by the base station when converting the SINR into a corresponding modulation order, then a valid TBS index is found, otherwise, repeat the converting step to try other modulation orders until all modulation orders have been verified.

Once the determined TBS index is validated, then the base station puts this value into the DCI field that was reserved for the 5 bits MCS field in the current systems.

In some embodiments, method 300 may further determine a modulation order based on the determined TBS index and the allocated resources. Then, method 300 may modulate user data with the determined modulation order. The base station can transmit the modulated user data to the wireless device. Method 300 may also comprise sending an indication of the allocated resources to the wireless device.

It should be noted that the TBS index and the transport block (or the allocated PRBs) are often transmitted in the same TTI, e.g. the TBS index is transmitted on the PDCCH and the transport block (e.g. PRBs) is transmitted on the PDSCH.

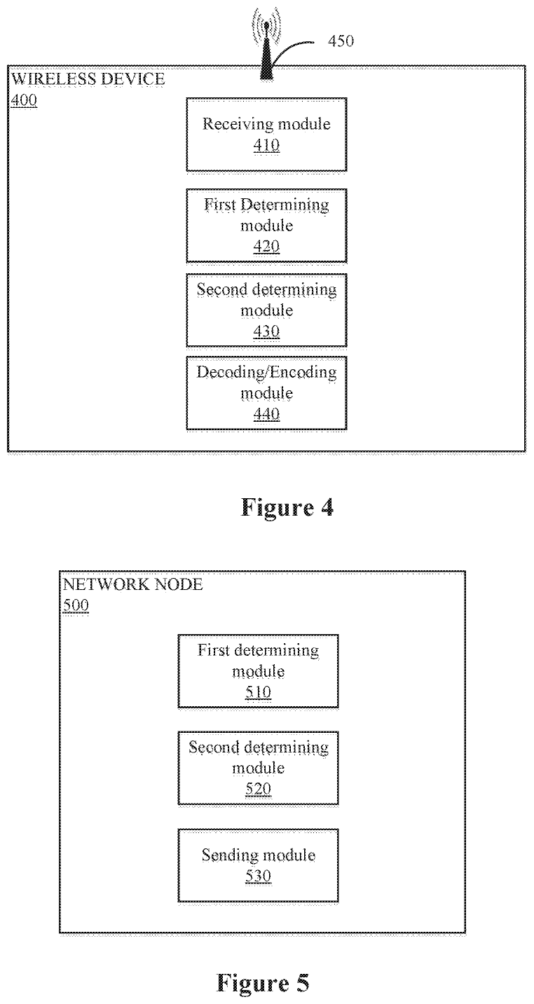

FIG. 4 illustrates an exemplary wireless device 400, according to an embodiment. The wireless device 400 may comprise an antenna 450 for example. It is understood that the wireless device 400 may comprise other components well-known in the art. The wireless device 400 is configured to perform method 200 of FIG. 2, for example. The wireless device 400 may comprise a receiving module 410, a first determining module 420, a second determining module 430 and a decoding/encoding module 440.

The receiving module 410 is configured to perform at least block 210 of method 200. The first determining module 420 is configured to perform at least block 220 of method 200. The second determining module 430 is configured to perform at least block 230 of method 200. The decoding/encoding module 440 is configured to perform at least block 240 of method 200.

FIG. 5 illustrates an exemplary network node (or base station) 500 according to an embodiment. The network node 500 is configured to perform method 300 of FIG. 3, for example. The network node 500 may comprise a first determining module 510, a second determining module 520 and a sending module 530.

The first determining module 510 is configured to perform at least block 310 of method 300. The second determining module 520 is configured to perform at least block 320 of method 300. The sending module 530 is configured to perform at least block 330 of method 300.

It should be understood that Formula (1) imposes an assumption that all layers within one codeword must use only one modulation. Also, it was proposed in the 5G standard to use 5 bits to represent the MCS index, and another 2 bits for 4 different redundant versions (RV/1/2/3) (see references 3GPP TS 36.212, E-UTRA Multiplexing and channel coding, V9.2.0). The redundant version RV0 is used for an initial transmission. If a negative acknowledgment (NACK) is received from the UE, another redundant version can be used for a re-transmission to enable the UE to implement a soft combination and thus improve the decoding performance.

The assumption imposed by Formula (1) that all layers within one codeword be of the same modulation is based on the assumption that all the layers within one codeword share the same channel quality. Unfortunately, such an assumption is too ideal to be met in the real air conditions. This is true especially in 5G enhanced Mobile Broadband (eMBB) scenario where terminals are required to yield a larger throughput, but they experience faster moving speed, which will result in bigger air channel differences among layers.

Therefore, the above assumption either impacts the throughput by aligning all the layers in a codeword to the lower modulation order or suffers from the potential Block Error Rate (BLER) by aligning of all the layers in a codeword to the higher modulation order.

In order to match better the link adaption to the complex air conditions in 5G NR, there is a need of a method that can support different modulations among multiple layers within one codeword.

The following embodiments provide support for different modulations among multiple layers without increasing the DCI size.

For example, by redefining the 2-bit RV field (which can be referred to as an indicator), not only the TBS levels in a new transmission are extended to 31 values, but also different modulations can be applied to different groups of layers in one codeword, without introducing additional bits in DCI. As such, the embodiments support different air conditions among multiples layers within one codeword without sacrificing the Physical Downlink Control Channel (PDCCH) decoding performance.

Method for support of two modulation orders for two groups of layers within one codeword:

A proposal for the 5G standard requires the DCI to have two independent fields related to the MCS and redundant version:
MCS (5 bits) is used to indicate the TBS as well as the modulation order; and
RV (2 bits) indicates the redundancy version.

It should be noted that for a new transmission (i.e. RV=0), 5-bit MCS can represent 32 (2⁵) values, among which 28-31 are reserved to explicitly indicate 4 modulations (QPSK, 16QAM, 64QAM and 256QAM) in retransmissions. However, the RV field itself already indicates the retransmission. Such a duplication not only limits the TBS levels in new transmissions (only 28 values are left for TBS), but also wastes valuable value range in retransmissions (4 values out of 32 ones are used to indicate modulation orders). As such, it can be seen that the 5G proposal does not utilize well the existing MCS and RV fields. Therefore, there is room left to reuse those two fields to indicate new information to a UE, such as the modulation order of a second group, for example.

Generally speaking, the embodiments redefine the 5-bit field (TBSI as described above) and 2-bit field (Redundancy Version or indicator) to implicitly indicate the modulation order of the second group based on the different requirements between a new transmission and a retransmission.

### New Transmission

In a new transmission, the UE needs to determine the TB size as well as the modulation order in order to successfully decode or encode the user data. The following two mechanisms are adopted:

### 1. Modulation Order Determination (See Above (e.g. Embodiment 1) for Details of That Method)

Through such a method, the network node doesn't have to explicitly specify the modulation order to the UE. Instead, only the TBS is explicitly indicated, based on which the modulation order can be derived based on the RE efficiency which can be calculated using the TBS.

### 2. RV Field Re-Usage

There is an implicit precondition that the new transmission must have RV0 as the redundant version. This means that the RV field of 2 bits is actually a duplicate field during the new transmission. As such, the 2 bits for RV can be reused to indicate the modulation order for the second group of layers to support different modulation orders among different layers if required.

### Retransmission

### 1. TBS Table

Since the TBS is already known by the UE due to the initial (new) transmission, the TBS index is not needed for a retransmission. Moreover, the modulation order determination method can be applied to retransmissions as well so that the UE can derive the modulation order in the retransmissions according to the TBS provided in the initial (new) transmission. As a result, the 4 explicit retransmission modulation indicators (28-31) in the TBS table (table 2) can be removed and the saved value space can be reused to represent more TBS levels.

### 2. RV Field

Unlike in the case of a new transmission, which always uses RV0, in the case of a retransmission, RV 1, 2, 3, or 0 can be used. Moreover, the selection of the redundancy version is completely up to the network node without any predetermined or fixed order, so that the RV field has to be used to indicate the specific redundancy version in retransmissions.

It should be noted that, since the RV field has been redefined to represent different meanings in a new transmission and a retransmission (see table 6), it means that the RV field is no longer used to distinguish a new transmission from a retransmission. Instead, the network node has to rely on another method to make the distinction. As an example, the present disclosure proposes to reserve a special value (31) out of the 32 TBS levels in the TBS index to indicate a retransmission.

Based on the above discussion, the present disclosure proposes the following embodiment:

### Embodiment 2 (Support Different Modulations Without Increasing the DCI Size by Reusing the Existing 2 Bits of the RV Field)

To achieve the trade-off between complexity and performance, two groups of layers in a codeword can use different modulation orders depending on their respective channel qualities. It is assumed that the codeword has 2 groups of layers, as an example, but the embodiments are not limited to codewords having two groups of layers.

To do so, Table 2 is restructured as a new TBS table (see Table 5), in which TBS indexes from 0 to 30 are used for a new transmission or a DTXed retransmission. TBS index 31 is used for a retransmission.

TABLE 5
Illustration of TBS Table (comprising quantized TBS values)
for embodiment 2

| | 1 | 2 | | 100 |
|---|---|---|---|---|
| TBS | nrofNominalRb | nrofNominalRbs | | nrofNominalRbs |
| Index | (N_{PRB}^{norm}) | (N_{PRB}^{norm}) | . . . | (N_{PRB}^{norm}) |
| 0 | TBS_{0,1} | TBS_{0,2} | . . . | TBS_{0,100} |
| 1 | TBS_{1,1} | TBS_{1,2} | . . . | TBS_{1,100} |
| . . . | . . . | . . . | . . . | . . . |
| 30 | TBS_{30,1} | TBS_{30,2} | . . . | TBS_{30,100} |

| | |
|---|---|
| 31 | Retransmission |

To align with the restructuration of the TBS table, the existing 2-bit field (that is used to be reserved for indicating the RV) also needs a redefinition as can be seen in table 6.

TABLE 6
2-bit field definition

| 5-bit | | | | | |
|---|---|---|---|---|---|
| TBS index | 2-bit field | 00 | 01 | 10 | 11 |
| [0 . . . 30] | Indicate | QPSK | 16QAM | 64QAM | 256QAM |
| indicates | modulation | | | | |
| new | order for the 2nd | | | | |
| transmission | group of layers | | | | |
| (RV = 0) | | | | | |
| 31 indicates | Indicate | RV0 | RV1 | RV2 | RV3 |
| Retrans- | redundant | | | | |
| mission | version | | | | |

For example, values [0-30] of the TBS index are used to indicate 31 TBS levels in a new transmission (RV=0). Meanwhile, the 2-bit that is used to be reserved for the RV field is reused to explicitly indicate the modulation order for the second group.

Value 31 of the TBS index is reserved to indicate a retransmission. Then in that case, the 2-bit RV field is used to indicate the redundancy version of the retransmission.

The following is a detailed method for a UE to decode or encode its user data, or user data block or transport block (TB) for a new transmission by assuming two groups of layers in the TB, which can have different modulation orders:

Step 42: Calculate the total actual number of REs, N_{RE1}, in the assigned physical layer resources for the first group of layers.

If it is assumed that all the assigned PRBs have the same number of REs, the total Number of REs for the first group can be calculated as:

N_{RE1}=N_{PRB}^{DL}×N_{RE}^{PRB}×Layer₁^{DL}

If not all the assigned PRBs have the same number of REs, the total Number of REs can be found through summing the number of REs from each of the assigned PRBs for the first group.

Step 44: Calculate the number of equivalent nominal resource blocks (N_{PRB}^{norm}) for the first group:

$${N}_{PRB}^{norm} = ⌈ \frac{{N}_{RE 1}}{{N}_{RE}^{PRB}} ⌉$$

Step 46: By using the TBS index for the first group and N_{RPB}^{norm} to look up table 6, the corresponding TBS value denoted as TBS₁ can be fetched.

Step 48: Calculate RE efficiency for the first group:

$${reEfficiency}_{1} = \frac{{TBS}_{1}}{{N}_{RE 1}}$$

Step 50: Search through the RE Efficiency Colum of the Table 3 to find the closest RE Efficiency value which is less than or equal to the calculated reEfficiency₁ and its corresponding modulation order, denoted as MO₁.

Step 52: Fetch modulation order of the 2^{nd} group MO₂ from the existing 2-bit RV field and calculate the TBS value for the 2^{nd} group:

$${TBS}_{2} = 8 \times ⌈ ( {TBS}_{1} \times \frac{{MO}_{2}}{{MO}_{1}} \times \frac{{Layer}_{2}}{{Layer}_{1}} ) / 8 ⌉$$

Then, the total TBS=TBS₁+TBS₂

Step 54: Calculate the total number of raw physical bits (the coded bits), N_{bits}, in the assigned physical layer resources, based on the number of PRBs assigned, the number of REs in each PRB, the modulation orders for each group of layers:

$${N}_{bits} = {\sum }_{1}^{2} ( {N}_{PRB}^{DL} \times {N}_{RE}^{PRB} \times {Layer}_{k}^{DL} \times {MO}_{k} )$$

Step 56: Calculate the code rate:

$${R}_{coding} = \frac{TBS}{{N}_{bits}}$$

step 58: Based on the TBS, code rate, and N_{bits}, the UE can try to decode or encode the user data or transport block. If the CRC is OK, an ACK will be sent to 5gNB, otherwise, a NACK will be sent.

For a retransmission, it is assumed that all the layers in a TB have the same modulation order. Since the UE already knows the TBS value from the original transmission, the modulation determination method described above can be used to determine its modulation order and its total number of raw bits. It should be soft-combined with the ones from all the previously transmitted redundant versions before decoding.

For a DTXed retransmission, if the UE already decoded the PDCCH successfully from the original transmission, it would know the TBS value and the DTXed retransmission will be treated as a retransmission. If the UE missed the PDCCH from the original transmission, the DTXed retransmission will be treated as a new transmission.

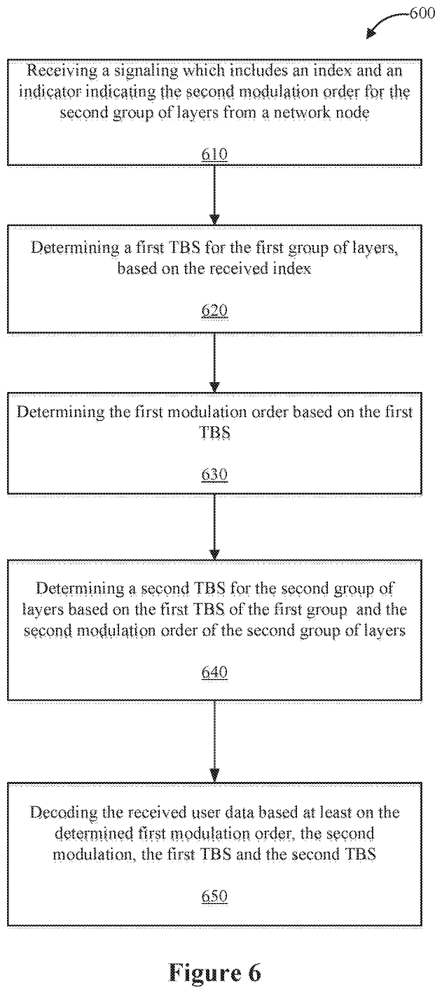

FIG. 6 illustrates a method 600 performed by a wireless device for decoding or encoding user data in a new transmission, the user data having a first modulation order for a first group of layers and a second modulation order for a second group of layers. The method 600 comprises: receiving a signaling which includes a first index, such as the first Transport Block Size (TBS) index of the first group of layers, and an indicator indicating the second modulation order for the second group of layers, from a network node (block 610). Method 600 comprises determining a first TBS for the first group of layers based on the received index (e.g. a TBS index) in block 620. Method 600 comprises determining the first modulation order based on the determined first TBS (block 630). Method 600 comprises determining a second TBS for the second group of layers based on the first TBS of the first group and the second modulation order of the second group of layers (block 640). Method 600 comprises decoding or encoding the user data based at least on the determined first modulation order, the second modulation order, the first TBS and the second TBS (block 650).

In some embodiments, the signalling may be a control signal such as a DCI signal, which comprises a first field for indicating a value of the TBS index in a transmission or a retransmission, and a second field for indicating the modulation order of the second group of layers in a transmission or a redundant version for a retransmission. The signalling may further comprise an indication of resources allocated to the wireless device.

In some embodiments, the TBS index indicates a TBS index value (e.g. values from 0 to 30, see table 5) for a transmission. The TBS index can also indicate a retransmission (e.g. value 31, see table 5).

In some embodiments, in block 620, determining the first TBS can be done as described in steps 42-46. It should be noted that the determined TBS corresponds to the TBS for the first group of layers.

In some embodiments, in block 630, determining the first modulation order can be done as described in steps 48-50.

In some embodiments, in block 640, determining the second TBS can be done as described in step 52.

In some embodiments, decoding or encoding the user data can be done as described in steps 54-58. For example, a total TBS can be calculated based on the first TBS for the first group and the second TBS for the second group. Then, a total number of coded bits can be determined and a code rate, which allows for decoding or encoding the user data together with the total TBS and total number of bits.

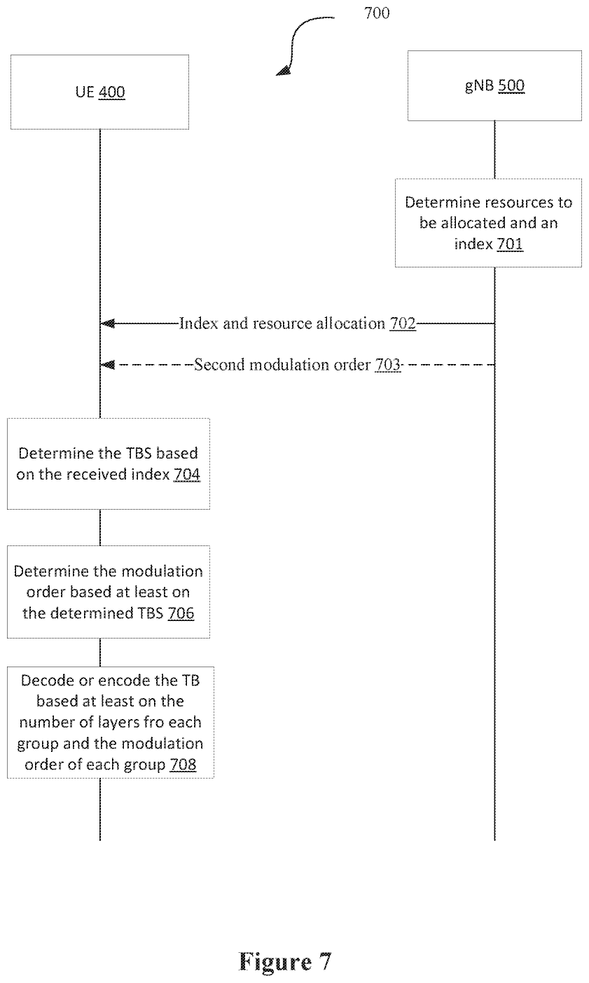

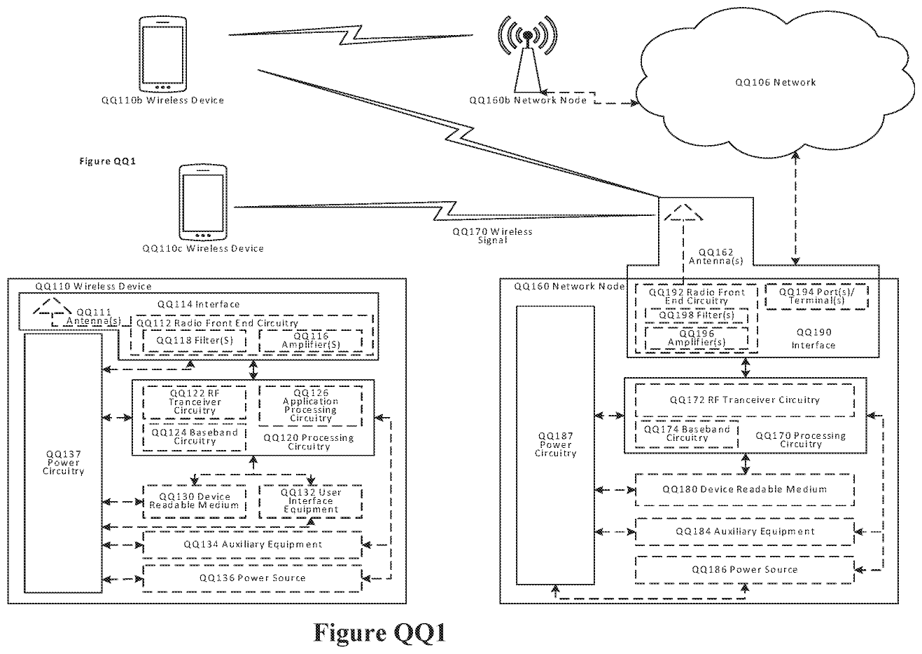

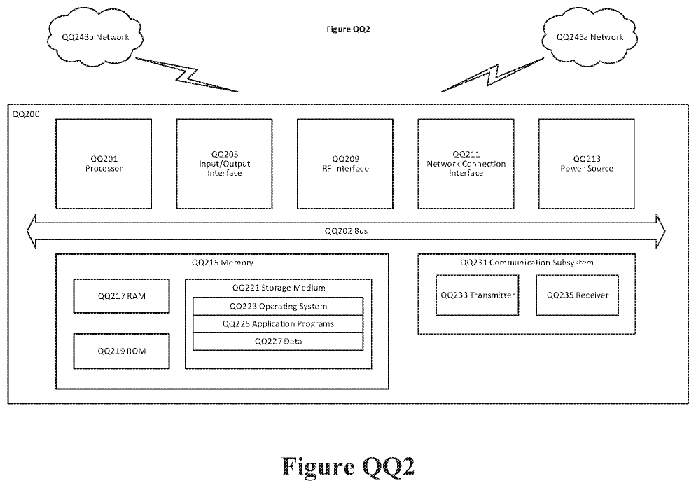

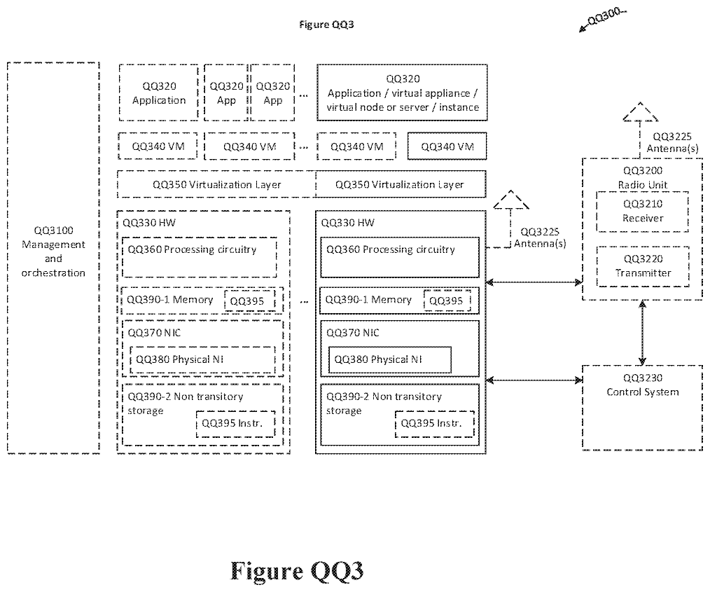

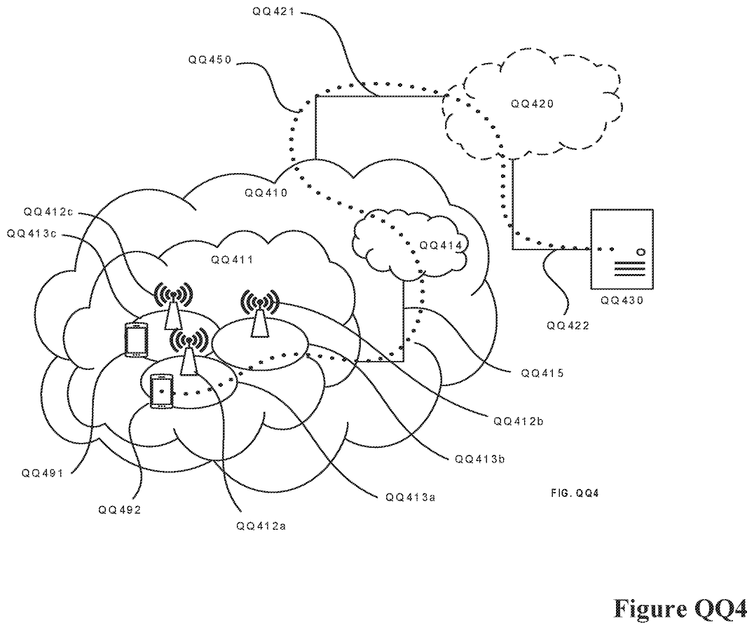

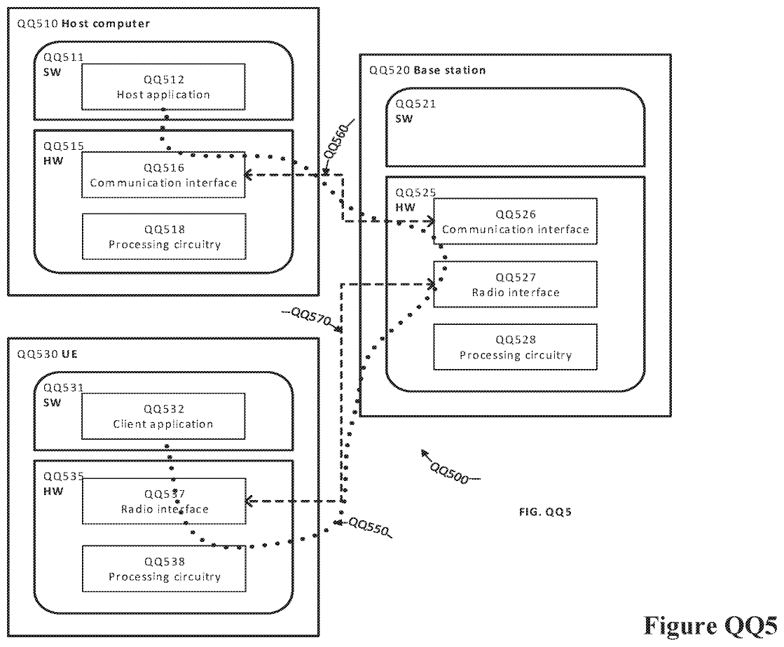

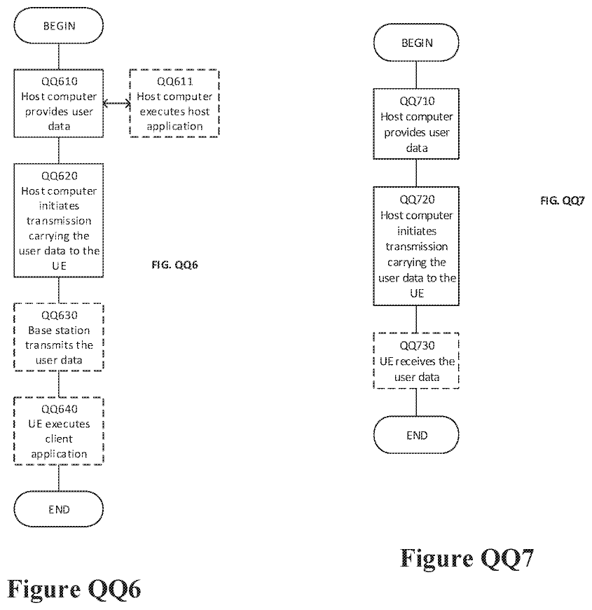

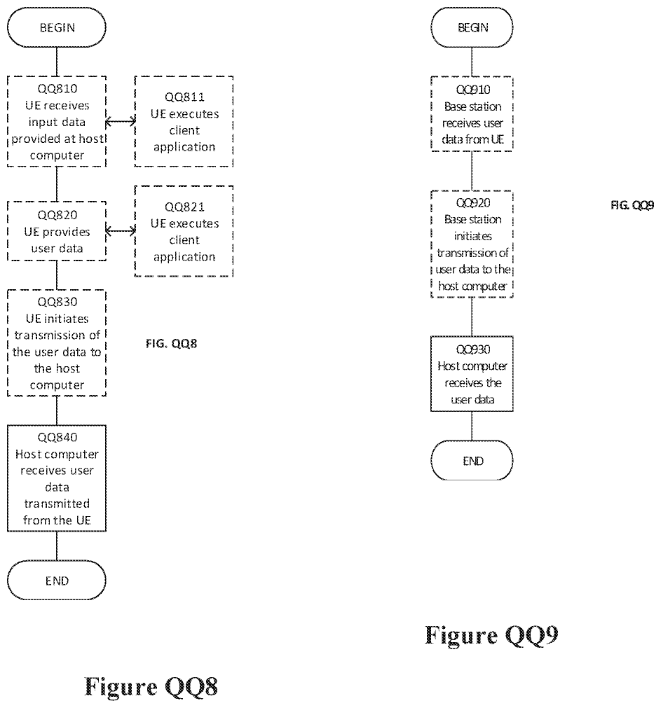

Now turning to FIG. 7, a general procedure for handling user data in a wireless network comprising one or more wireless devices (e.g. 400) and one or more network nodes (e.g. 500), according to embodiment 1 or 2, will be described.

In step 701: the gNB or base station, such as 500, determines resources allocated to the wireless device, such as 400. The base station also determines an index, based on the allocated resources. The index can be the TBS index.

In step 702, the base station sends the determined index to the wireless device. It can also send an indication of the allocated resources to the wireless device. The index and indication of the allocated resources can be sent in the same message or in different messages.

In step 703, in the case where the user data are converted into a codeword having 2 groups of layers, where the first group has a first modulation order and the second group has a second modulation order which is different from the first modulation order, the base station may send an indicator comprising the second modulation order to the wireless device, using the 2 bits used to indicate the redundant version, for example.

In step 704, the wireless device determines a TBS based on the received index. Alternatively, the wireless device can determine the first TBS, for the first group of layers.

In step 706, the wireless device determines a modulation order based at least on the determined TBS. Alternatively, the wireless device can determine the first modulation order based on the first TBS, for the first group.

In step 708, the wireless device either decodes or encodes the user data based at least on the determined modulation order. Alternatively, the wireless device can decode or encode the user data based on the first TBS, the first modulation order, the second modulation order and a second TBS, determined based on the second modulation order, for example.

As mentioned above, the values of the received index according to the embodiment 1 are between [0 to 27] for indicating a TBS index in a transmission and the values of the index between [28-31] are used to indicate a modulation order for a retransmission. For the embodiment 1, the 2 groups of layers have the same modulation order.

For the embodiment 2, the received index may correspond to the TBS index and have values from [0 to 30] for a transmission. The value of 31 is used to indicate a retransmission of the user data.

Although the subject matter described herein may be implemented in any appropriate type of system using any suitable components, the embodiments disclosed herein are described in relation to a wireless network, such as the example wireless network illustrated in FIG. QQ1. For simplicity, the wireless network of FIG. QQ1 only depicts network QQ106, network nodes QQ160 and QQ160b, and WDs QQ110, QQ110b, and QQ110c. The network nodes QQ160 may correspond to network nodes 500, and the WDs QQ110 may correspond to wireless devices 400. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, and evolved Node Bs (eNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. QQ1, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. QQ1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination. For example, processing circuitry QQ170 is configured to perform the operations of methods 300.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signaling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. QQ1 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as a machine-type communication (MTC) device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination. For example, the processing circuitry QQ120 may be configured to perform the operations methods 200 and 600.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110 and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

FIG. QQ2 illustrates one embodiment of a UE, such as the wireless 400, in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user. A UE may also comprise any UE identified by the 3^{rd} Generation Partnership Project (3GPP), including a NB-IoT UE that is not intended for sale to, or operation by, a human user. UE QQ200, as illustrated in FIG. QQ2, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. QQ2 is a UE, the components discussed herein are equally applicable to a WD, and vice-versa.

In FIG. QQ2, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. QQ2, or only a subset of the components. The level of integration between the components may vary from one UE to another UE. Further, certain UEs may contain multiple instances of a component, such as multiple processors, memories, transceivers, transmitters, receivers, etc.

In FIG. QQ2, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor

In FIG. QQ2, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. QQ2, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

FIG. QQ3 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node, such as network nodes 500 and QQ160 (e.g., a virtualized base station or a virtualized radio access node) or to a device such as wireless devices 400 and QQ110 (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. QQ3, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. QQ3.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

With reference to FIG. QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs (such as QQ160 or 500) or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 (corresponding to QQ110 or 400) located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. QQ4 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

Example implementations, in accordance with an embodiment, of the UE, base station and host computer discussed in the preceding paragraphs will now be described with reference to FIG. QQ5. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. QQ5) served by base station QQ520. Communication interface QQ526 may be configured to facilitate connection QQ560 to host computer QQ510. Connection QQ560 may be direct or it may pass through a core network (not shown in FIG. QQ5) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application

QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. QQ5 may be similar or identical to host computer QQ430, one of base stations QQ412a, QQ412b, QQ412c and one of UEs QQ491, QQ492 of FIG. QQ4, respectively. This is to say, the inner workings of these entities may be as shown in FIG. QQ5 and independently, the surrounding network topology may be that of FIG. QQ4.

In FIG. QQ5, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

FIG. QQ6 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ6 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. QQ7 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ7 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

FIG. QQ8 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ8 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. QQ9 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. QQ9 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The above-described embodiments are intended to be examples only. Alterations, modifications and variations may be effected to the particular embodiments by those of skill in the art without departing from the scope of the description, which is defined solely by the appended claims.

### ABBREVIATION

### 3 GPP Third Generation Partnership Project QAM Quadrature Amplitude Modulation E-UTRA Evolved UTRA UTRA Universal Terrestrial Radio Access QPSK Quadrature Phase Shift Keying

What is claimed is:

1. A method performed by a wireless device for handling user data, the method comprising:
receiving a signaling comprising an index from a network node;
determining a Transport Block Size (TBS) based on the received index;
determining a modulation order based at least on the determined TBS; and
performing one of decoding and encoding the user data based at least on the determined modulation order.

2. The method of claim 1, further comprising receiving an indication of resource blocks allocated to the wireless device by the network node.

3. The method of claim 1 or 2, where the received index is a Transport Block Size (TBS) index.

4. The method of claim 3, wherein determining the modulation order based at least on the determined TBS comprises:
determining the TBS based on the received TBS index and a nominal number of resource blocks;
determining a resource element (RE) efficiency based on the determined TBS and a number of REs in the allocated resource blocks; and
determining the modulation order based on the determined resource element efficiency.

5. The method of claim 4, wherein the nominal number of resource blocks is determined by scaling a total number of resource elements in the resource blocks allocated by the network node to the wireless device with a factor.

6. The method of claim 4 or 5, wherein determining the TBS based on the received TBS index further comprises looking up a 2-dimensional table to find a value of the TBS corresponding to the received TBS index and the nominal number of resource blocks.

7. The method of any one of claims 3 to 6, wherein determining the modulation order comprises:
looking up a table of RE efficiency to determine the modulation order corresponding to the determined RE efficiency.

8. The method of any one of claims 3 to 6, wherein determining the modulation order comprises comparing the determined RE efficiency with a set of threshold values of RE efficiency and selecting a corresponding modulation order.

9. The method of any one of claims 3 to 8, wherein determining the resource element (RE) efficiency is further based on a total number of resources elements in the resource blocks allocated by the network to the wireless device.

10. The method of claim 3, further comprising determining a total number of coded bits based on the modulation order and a total number of resource elements in the assigned resource blocks.

11. The method of claim 10, wherein performing one of decoding and encoding the user data further comprises one of decoding and encoding the user data based on the determined TBS and the total number of coded bits.

12. The method of any one of claims 3 to 11, wherein the TBS index has a value from 0 to 27 for a transmission.

13. The method of any one of claims 3 to 12, wherein values of 28 to 31 of the TBS index are used to indicate a modulation order for a retransmission.

14. The method of any one of claims 3 to 13, wherein the user data has a first group of layers and a second group of layers.

15. The method of claim 14, wherein the first and second groups of layers have a same modulation order.

16. The method of claim 14, wherein the first group of layers has a first modulation order and the second group of layers has a second modulation order, the first modulation order being different from the second modulation order.

17. The method of claim 16, wherein determining the TBS based on the received index comprises determining a first TBS for the first group of layers.

18. The method of claim 16 or 17, wherein the signaling further comprises an indicator.

19. The method of claim 18, wherein the indicator indicates the second modulation order of the second group of layers.

20. The method of claim 19, wherein determining the modulation order comprises determining the first modulation order based on the determined first TBS.

21. The method of claim 20, further comprising determining a second TBS for the second group of layers based on the first TBS of the first group of layers and the second modulation order of the second group of layers.

22. The method of claim 21, wherein performing one of decoding and encoding the user data is based on the determined first modulation order, the second modulation order, the first TBS and the second TBS.

23. The method of any one of claims 17 to 22, wherein the received index is a TBS index.

24. The method of claim 23, wherein determining the first TBS comprises determining the first TBS based on the received TBS index and a nominal number of resource blocks for the first group of layers.

25. The method of claim 24, further comprising determining a total TBS based on the first TBS for the first group of layers and the second TBS for the second group of layers.

26. The method of claim 25, further comprising determining a code rate based on the determined total TBS and the total number of coded bits.

27. The method of claim 26, wherein performing one of decoding and encoding the received user data further comprises performing one of decoding and encoding the received user data based at least on the determined code rate.

28. The method of any one of claims 23 to 27, wherein a value of the TBS index is one of 0 to 30 for a transmission of the user data.

29. The method of claims 23, wherein a value of the TBS index is 31, which is used to indicate a retransmission of the user data.

30. The method of claim 29, wherein the indicator indicates a redundancy version.

31. A wireless device adapted to:
receive an index from a network node;
determine a Transport Block Size (TBS) based on the received TBS index;
determine a modulation order based at least on the determined TBS; and
perform one of decoding and encoding user data based at least on the determined modulation order.

32. The wireless device of claim 31, wherein the wireless device is further adapted to operate according to the method of any of claims 2 to 30.

33. A computer program product comprising a non-transitory computer readable storage medium having computer readable program code embodied in the medium, the computer readable program code comprising:
computer readable program code to receive an index from a network node;
computer readable program code to determine a Transport Block Size (TBS) based on the received index;
computer readable program code to determine a modulation order based at least on the determined TBS; and
computer readable program code to perform one of decoding and encoding user data based at least on the determined modulation order.

34. The computer program product of claim 33, wherein the computer readable program code further comprises computer readable program code to operate according to the method of any of claims 2 to 30.

35. A wireless device for decoding a received transport block, the wireless device comprising:
a communication interface configured to communicate with other nodes;
processing circuitry configured to perform any of the methods of claims 1 to 30; and
power supply circuitry configured to supply power to the wireless device.

36. The wireless device of claim 35, wherein the processing circuitry comprises a processor and a memory connected thereto, the memory containing instructions that, when executed, cause the processor to perform any of the methods of claims 1 to 30.

37. A user equipment (UE) for decoding a received transport block, the UE comprising:
an antenna configured to send and receive wireless signals;
radio front-end circuitry connected to the antenna and to processing circuitry, and configured to condition signals communicated between the antenna and the processing circuitry; the processing circuitry being configured to perform any of the steps of any of the methods 1 to 30;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

38. A method performed by a base station for allocating resources for a transmission of user data to a wireless device, the method comprising:
determining the resources to be allocated to the wireless device;
determining an index based at least on the determined resources allocated to the wireless device; and
sending the determined index to the wireless device.

39. The method of claim 38, further comprising sending an indication of the allocated resources to the wireless device.

40. The method of claim 38 or 39, further comprising determining a Transport Block Size (TBS) based on the allocated resources.

41. The method of any one of claims 38 to 40, wherein the determined index is a TBS index.

42. The method of claim 41, wherein the TBS index is determined based on the determined TBS and a number of nominal Physical Resource Blocks (PRBs).

43. The method of claim 42, further comprising looking up a 2-dimensional table of TB sizes and numbers of nominal Physical Resource Blocks (PRBs) to find a quantized TBS value closest to the determined TBS whose row number corresponds to the TBS index.

44. The method of claim 43, further comprising validating the determined TBS index by calculating an actual resource element (RE) efficiency based on the quantized TBS.

45. The method of claim 44, further comprising determining a modulation order from the calculated actual RE efficiency using a table of RE efficiency that is used by the wireless device.

46. A base station adapted to:
determine the resources to be allocated to the wireless device;
determine an index based at least on the determined resources allocated to the wireless device; and
send the determined index to the wireless device.

47. The base station of claim 46, wherein the base station is further adapted to operate according to the method of any of claims 38 to 45.

48. A computer program product comprising a non-transitory computer readable storage medium having computer readable program code embodied in the medium, the computer readable program code comprising:
computer readable program code to determine the resources to be allocated to the wireless device;
computer readable program code to determine an index based at least on the determined resources allocated to the wireless device;
computer readable program code to send the determined index to the wireless device.

49. The computer program product of claim 48, wherein the computer readable program code further comprises computer readable program code to operate according to the method of any of claims 38 to 45.

50. A base station for allocating resources for a transmission from a wireless device, the base station comprising:
a communication interface configured to communicate with other nodes;
processing circuitry configured to perform any of the steps of any of the methods 38 to 45;
power supply circuitry configured to supply power to the base station.
